(19) United States
(12) Patent Application Publication
(10) Pub. No.: US 2025/0007597 A1
(43) Pub. Date: Jan. 2, 2025

(54) USER EQUIPMENT (UE) BEAM PREDICTION WITH MACHINE LEARNING

(71) Applicant: Nokia Technologies Oy, Espoo (FI)

(72) Inventors: Qiping ZHU, Naperville, IL (US); Jie CHEN, Naperville, IL (US)

(21) Appl. No.: 18/710,304

(22) PCT Filed: Nov. 22, 2021
(86) PCT No.: PCT/US2021/072561

§ 371 Date: May 15, 2024

(51) Int. Cl. H04B 7/06; H04L 5/00; H04W 24/04; H04W 72/044; H04W 72/231

(52) U.S. Cl. CPC H04B 7/06966; H04L 5/0048; H04W 24/04; H04W 72/046; H04W 72/231

(57) ABSTRACT

Various techniques are provided for communicating a request for channel prior information associated with another entity, receiving the channel prior information, predicting a beam for communication between the UE and the network device based on the channel prior information and using a machine learning beam prediction model, indicating channel state information-reference signal (CSI-RS) resource information from a CSI-RS resource table based on the predicted beam, and communicating selected CSI-RS resource information.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3rd Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process to meet the requirements of 5G, similar to earlier evolution of 3G and 4G wireless networks. 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency.

### SUMMARY

In a general aspect, a device, a system, a non-transitory computer-readable medium (having stored thereon computer executable program code which can be executed on a computer system), and/or a method can perform a process with a method including communicating, by the UE to a network device, a request for channel prior information associated with another entity, receiving, by the UE from the network device, the channel prior information, predicting, by the UE, a beam for communication between the UE and the network device based on the channel prior information and using a machine learning beam prediction model, indicating, by the UE, channel state information-reference signal (CSI-RS) resource information from a CSI-RS resource table based on the predicted beam, and communicating, by the UE to the network device, selected CSI-RS resource information.

Implementations can include one or more of the following features. For example, the indicating of the CSI-RS resource information can be further based on at least one of a UE previous downlink (DL) reference signal (RS) measurement and a requested number of beam measurements. The method can further include signalling, by the UE to the network device, a beam prediction capability of the UE and communicating, by the UE to the network device, location information associated with the UE. The method can further include signalling, by the UE to the network device, the UE is capable of beam prediction using a sequence of integers in a field of an RRC UE capability report. The method can further include measuring a downlink (DL) reference signal (RS), wherein predicting the beam is further based on the DL RS measurement. The channel prior information can include at least one of an arrival angle spread statistic, a departure angle spread statistic, a channel multipath number, a channel multipath number strength, arrival angles coherence time, and departure angles coherence time.

For example, the arrival angle spread statistic can be based on data associated with another UE collected over different times as stored by the network device. The request for channel prior information can be a bit sequence communicated using MAC CE signalling indicating selected channel prior information. The method can further include selecting a trained beam prediction model based on at least one of the channel prior information, a panel capability associated with the UE, and a previous DL RS measurement of the UE. The indicating of the CSI-RS resource information can be further based on one of a SINR range and an angular spread. The method can further include determining whether or not the beam prediction has failed and in response to determining the beam prediction has failed, indicating default CSI-RS resource information. The communicating of the selected CSI-RS resource information can include indicating a selection of CSI-RS resources using a RRC UE capability report including a sequence of integers. The beam prediction model can be a neural network. The neural network can be configured to map an incident signal to a best beam received by the UE for communication between the UE and the network device.

In a general aspect, a device, a system, a non-transitory computer-readable medium (having stored thereon computer executable program code which can be executed on a computer system), and/or a method can perform a process with a method including receiving, by a network device from a user equipment (UE), a request for channel prior information, determining, by the network device, channel prior information associated with the UE, communicating, by the network device to the UE, the channel prior information associated with the UE, and receiving, by the network device from the UE, an indication of a plurality of UE receive beam channel state information-reference signal (CSI-RS) resource information and a value indicating a quantity of indicated UE receive beam options.

Implementations can include one or more of the following features. For example, the method can further include determining, by the network device, a CSI-RS resource type and a CSI-RS resource density based on the CSI-RS resource information. The method can further include triggering, by the network device, a UE beam refinement process based on a CSI-RS resource type and a CSI-RS resource density. The method can further include receiving a signal, by the network device from the UE, indicating a beam inferring capability of the UE and receiving, by the network device from the UE, location information associated with the UE. The channel prior information can include at least one of an arrival angle spread statistic, a departure angle spread statistic, a channel multipath number, and a channel multipath number strength, arrival angles coherence time, and departure angles coherence time. The request for channel prior information can be a bit sequence communicated using MAC CE signalling indicating selected channel prior information.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2A is a diagram illustrating a user equipment (UE) beam configuration according to an example embodiment.

FIG. 2B is a diagram illustrating a UE beam configuration according to an example embodiment.

FIG. 2C is a diagram illustrating a UE beam configuration according to an example embodiment.

FIG. 2D is a diagram illustrating a UE beam configuration according to an example embodiment.

FIG. 3A is a block diagram illustrating a machine learning beam prediction model according to an example embodiment.

FIG. 3B is a block diagram illustrating a portion of the machine learning beam prediction model according to an example embodiment.

FIG. 4 is a block diagram illustrating a signal flow for UE beam prediction according to an example embodiment.

FIG. 5 is a block diagram illustrating a method for UE beam prediction according to an example embodiment.

FIG. 6 is a block diagram of a wireless station or wireless node (e.g., AP, BS, gNB, RAN node, relay node, UE or user device, network node, network entity, DU, CU-CP, CU-CP, . . . or other node) according to an example embodiment.

FIG. 7 is a block diagram illustrating a method for operating a UE according to an example embodiment.

FIG. 8 is a block diagram illustrating a method for operating a network device (e.g., gNB) according to an example embodiment.

### DETAILED DESCRIPTION

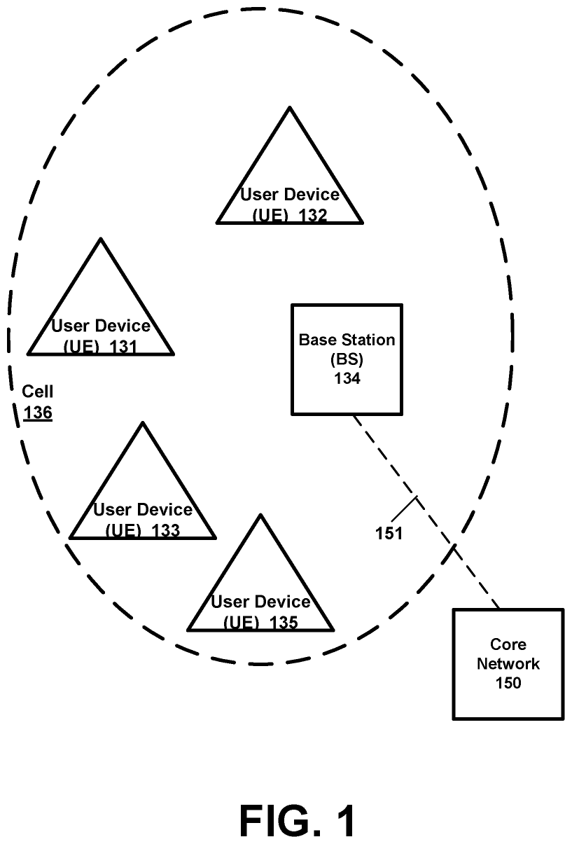

FIG. 1 is a block diagram of a wireless network 130 according to an example embodiment. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a BS, next generation Node B (gNB), a next generation enhanced Node B (ng-eNB), or a network node. The terms user device and user equipment (UE) may be used interchangeably. A BS may also include or may be referred to as a RAN (radio access network) node, and may include a portion of a BS or a portion of a RAN node, such as (e.g., such as a centralized unit (CU) and/or a distributed unit (DU) in the case of a split BS). At least part of the functionalities of a BS (e.g., access point (AP), base station (BS) or (e) Node B (eNB), BS, RAN node) may also be carried out by any node, server or host which may be operably coupled to a transceiver, such as a remote radio head. BS (or AP) 134 provides wireless coverage within a cell 136, including to user devices (or UEs) 131, 132, 133 and 135. Although only four user devices (or UEs) are shown as being connected or attached to BS 134, any number of user devices may be provided. BS 134 is also connected to a core network 150 via a SI interface or NG interface 151. This is merely one simple example of a wireless network, and others may be used.

A base station (e.g., such as BS 134) is an example of a radio access network (RAN) node within a wireless network. A BS (or a RAN node) may be or may include (or may alternatively be referred to as), e.g., an access point (AP), a gNB, an eNB, or portion thereof (such as a centralized unit (CU) and/or a distributed unit (DU) in the case of a split BS or split gNB), or other network node. For example, a BS (or gNB) may include: a distributed unit (DU) network entity, such as a gNB-distributed unit (gNB-DU), and a centralized unit (CU) that may control multiple DUs. In some cases, for example, the centralized unit (CU) may be split or divided into: a control plane entity, such as a gNB-centralized (or central) unit-control plane (gNB-CU-CP), and an user plane entity, such as a gNB-centralized (or central) unit-user plane (gNB-CU-UP). For example, the CU sub-entities (gNB-CU-CP, gNB-CU-UP) may be provided as different logical entities or different software entities (e.g., as separate or distinct software entities, which communicate), which may be running or provided on the same hardware or server, in the cloud, etc., or may be provided on different hardware, systems or servers, e.g., physically separated or running on different systems, hardware or servers.

As noted, in a split configuration of a gNB/BS, the gNB functionality may be split into a DU and a CU. A distributed unit (DU) may provide or establish wireless communications with one or more UEs. Thus, a DUs may provide one or more cells, and may allow UEs to communicate with and/or establish a connection to the DU in order to receive wireless services, such as allowing the UE to send or receive data. A centralized (or central) unit (CU) may provide control functions and/or data-plane functions for one or more connected DUs, e.g., including control functions such as gNB control of transfer of user data, mobility control, radio access network sharing, positioning, session management etc., except those functions allocated exclusively to the DU. CU may control the operation of DUs (e.g., a CU communicates with one or more DUs) over a front-haul (Fs) interface.

According to an illustrative example, in general, a BS node (e.g., BS, eNB, gNB, CU/DU, . . . ) or a radio access network (RAN) may be part of a mobile telecommunication system. A RAN (radio access network) may include one or more BSs or RAN nodes that implement a radio access technology, e.g., to allow one or more UEs to have access to a network or core network. Thus, for example, the RAN (RAN nodes, such as BSs or gNBs) may reside between one or more user devices or UEs and a core network. According to an example embodiment, each RAN node (e.g., BS, eNB, gNB, CU/DU, . . . ) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node, and sending data to and/or receiving data from one or more of the UEs. For example, after establishing a connection to a UE, a RAN node (e.g., BS, eNB, gNB, CU/DU . . . ) may forward data to the UE that is received from a network or the core network, and/or forward data received from the UE to the network or core network. RAN nodes (e.g., BS, eNB, gNB, CU/DU, . . . ) may perform a wide variety of other wireless functions or services, e.g., such as broadcasting control information (e.g., such as system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node or BS may perform. A base station may also be DU (Distributed Unit) part of IAB (Integrated Access and Backhaul) node (a.k.a. a relay node). DU facilitates the access link connection(s) for an IAB node.

A user device (user terminal, user equipment (UE), mobile terminal, handheld wireless device, etc.) may refer to a portable computing device that includes wireless mobile communication devices operating either with or without a subscriber identification module (SIM) (which may be referred to as Universal SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network. A user device may be also MT (Mobile Termination) part of IAB (Integrated Access and Backhaul) node (a.k.a. a relay node). MT facilitates the backhaul connection for an IAB node.

In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. Other types of wireless networks, such as 5G (which may be referred to as New Radio (NR)) may also include a core network (e.g., which may be referred to as 5GC in 5G/NR).

In addition, by way of illustrative example, the various example embodiments or techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), massive MTC (mMTC), Internet of Things (IoT), and/or narrow band IoT user devices, enhanced mobile broadband (eMBB), and ultra-reliable and low-latency communications (URLLC). Many of these new 5G (NR)-related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10⁻⁵ and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to an eMBB UE (or an eMBB application running on a UE).

The various example embodiments may be applied to a wide variety of wireless technologies or wireless networks, such as LTE, LTE-A, 5G (New Radio (NR)), cmWave, and/or mmWave band networks, IoT, MTC, eMTC, mMTC, eMBB, URLLC, etc., or any other wireless network or wireless technology. These example networks, technologies or data service types are provided only as illustrative examples.

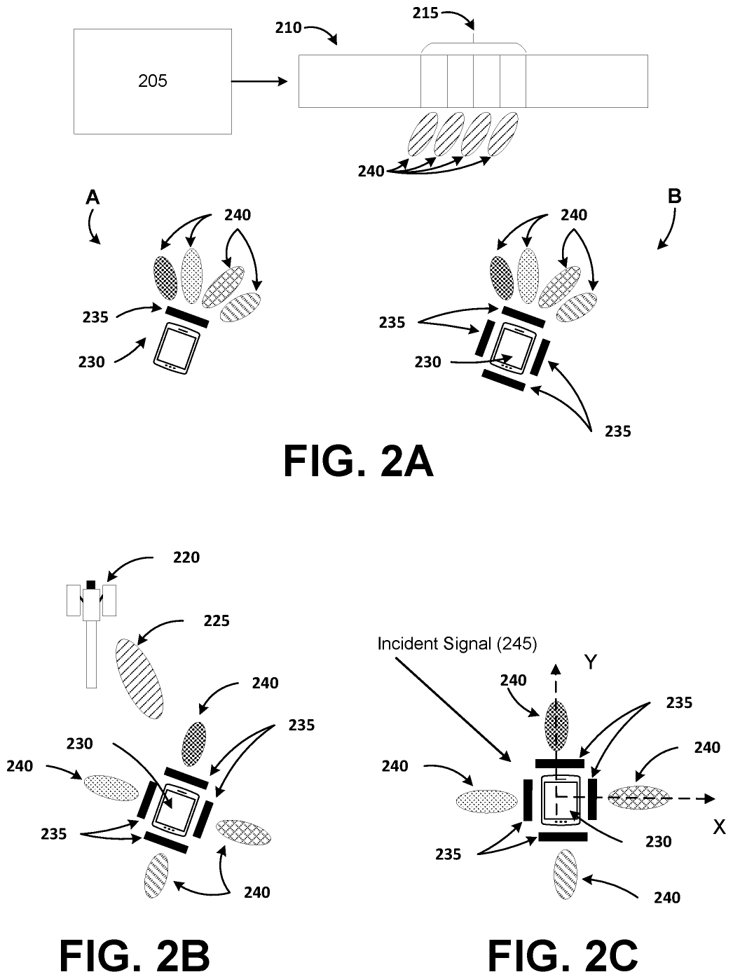

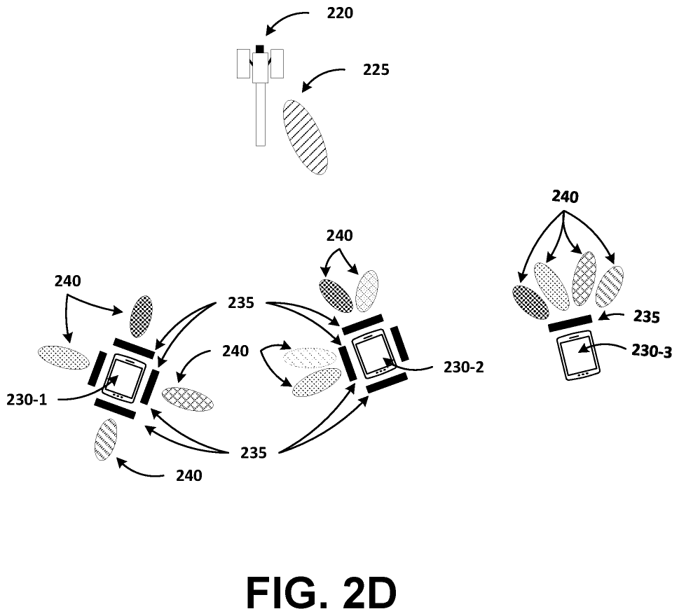

FIG. 2A is a diagram illustrating a UE beam configuration according to an example embodiment. The UE beam configuration can be used to describe a UE beam refinement. A UE 230 can include at least one panel 235. The panel 235 can be configured to generate at least one beam. For example, combination A shows the UE having one (1) panel 235 with four (4) beams 240) and combination B shows the UE having four (4) panel 235 with four (4) beams 240 on one (1) of the panels 235. Other combinations of the number of panels 235 and the number of beams 240 are within the scope of this disclosure. The UE can be configured to initiate activation of the at least one panel 235 for downlink (DL) and/or uplink (UL) beam (e.g., beam 240) measurement.

For example, to facilitate DL RX beam selection for a UE (e.g., UE 230), panel activation (e.g., for DL/UL measurement) can be defined as activating L out of P available panel(s) 235 at least for the purpose of DL beam measurements (e.g., reception of a DL measurement reference signal (RS)). Panel (e.g., panel 235) selection (e.g., for UL transmission) can be defined as selecting 1 out of L activated UE panel(s) 235 for the purpose of UL transmission. In another example implementation, for DL RX beam selection with single panel (SP) UE, only one panel is active, and the active panel can be for both DL beam measurement and UL transmission. A single panel UE can be a special case of multi-panel UE with L=P=1. In radio frequency range FR2, finding the best network device-UE (e.g., gNB-UE) beam pair may include sweeping both the candidate beams in the network device (e.g., gNB) and the candidate beams in the UE 230. Specifically, the procedure for beam 240 sweeping/refinement can include the network device transmitting DCI with indicating A-CSI triggering (block 205) and then transmits multiple A-CSI resource symbols 215 in PDSCH 210. Each A-CSI resource can be transmitted with the same TX beam at the network device and the UE 230 can measure different A-CSI resources with different UE RX beams. The UE 230 can determine the best RX beam based on the DL RS measurement.

FIG. 2B is a diagram illustrating a UE beam configuration according to an example embodiment. The UE 230 beam 240 configuration can include receiving a DL RS 225 from a network device (e.g., gNB) 220. The UE 230 can be a MP-UE and can activate multiple panels 235 for DL RS 225 measurement. The UE panels 235 can be placed in fixed positions of the UE 230. Therefore, the DL RS 225 measurements from UE panels 235 can be correlated. FIG. 2B shows an MP-UE measures the DL RS 225 with four (4) active panels 235 each having one (1) beam 240. Assuming the UE 230 is locating in an x-y plane like FIG. 2C. An incident signal 245 can be projected into x-y plane as shown. In this example, the UE 230 can activate four (4) panels 235 and simultaneously measure the DL RS 225 while each panel 235 uses a fixed beam 240 (e.g., RX beam).

In another example implementation, for UE 230 as single panel UE, UE 230 can receive the DL RS with a subset of the possible beams. For example, as shown in FIG. 2A, the UE 230 has 4 possible beams and the UE 230 can use two of the beams 240 to receive the DL RS. The measurements of the DL RS from the beams 240 can be correlated because all the possible beams point to fix directions.

The received signal of the projected incident signal at panel-i for SP-UE and/or MP-UE can be expressed as

$${y}_{i} = {w}_{i}^{H} {H}_{i} f x + {w}_{i}^{H} n \qquad ( 1 )$$

where:
   f is the transmitted beamforming vector,
   wᵢ^{H} is receiving beamforming vector,
   Hᵢ is the channel,
   n is noise, x is the reference signal, and
   yᵢ is the received signal.

### Considering a Rank-1 Channel

$${H}_{i} = {a}_{i} a ( {θ}_{i} ) {a ( ϕ )}^{H} \qquad ( 2 )$$

where:
   aᵢ is the fading coefficient, and
   a is the spatial signature.
Let

$$f = \frac{{a ( ϕ )}^{H}}{\sqrt{N}} ,$$

then the received signal at panel-i can be written as

$${y}_{i} = {a}_{i} \frac{1 - {e}^{- j k N ( cos ( {θ}_{i} ) - cos ( {θ\_w}_{i} ) )}}{1 - {e}^{- j k ( cos ( {θ}_{i} ) - cos ( {θ}_{w i} ) )}} + {n}_{i} \qquad ( 3 )$$

For SP-UE and/or MP-UE, one heuristic signal formulation is to choose amplitude and ratio as the mapping functions, the incident signal 245 can be represented as

$$( \frac{\vert {y}_{1} \vert}{\vert {y}_{2} \vert} , \frac{\vert {y}_{1} \vert}{\vert {y}_{3} \vert} , \frac{\vert {y}_{1} \vert}{\vert {y}_{4} \vert} ) .$$

Given all candidate beams from all the panels 235, each candidate beam can have a unique signal representation (e.g., code) based on candidate beams unique directed incident angle. Then for any incident signal 245, the best beam can be selected as the beam that has the shortest Euclidean distance to the incident signal 245 representation.

The incident signal 245 representation can depend on the choosing mapping function and the beam tapping window (e.g., reshape the beam pattern). However, a problem can be that the optimal designs of the mapping functions and the tapping window that maximize the distances between the candidate beams are unknown. In addition, the channel can be a multiple cluster channel, and which can be much more complicated than a rank-1 channel model. According to at least one example implementation, the problem can be solved utilizing machine learning to generate or predict a nonlinear beam prediction algorithm (e.g., an incident signal representation decoding algorithm) for practical UE beam refinement based on less symbols (e.g., indicating using less resources in time compared to the exhaustive search) of DL RS 225 measurements from multiple active UE 230 panels 235.

FIG. 2D is a diagram illustrating a UE beam configuration according to an example embodiment. FIG. 2D illustrates an example implementation showing a different panel capability can use a different number set of beams to measure DL RS 225. For example, UE 230-1 shows four (4) panels 235 activated each with one (1) beam, and UE 230-2 shows two (2) panels 235 activated each with two (2) beams.

In an example implementation, different beam prediction performances can cause the required number of CSI-RS resources in time for the UE beam prediction process can be different. For example, a less capable UE may use more than multiple beams from the active panel(s) to measure the DL RS 225 for beam 240 refinement and a more capable UE may only need one set of beams 240 (e.g., because of more active panels) from the active panels. DL RS measurements from multiple UE panels can be invariant to UE position and invariant to any specific cells. DL RS measurements can be based on the UE specific correlations of the DL RS measurements from multiple UE panels and the radio channel property.

The UE can be configured to activate one or more antenna panels to measure the DL RS and the measurements can be the input for the machine learning beam prediction model. In order to collect the measurement for beam prediction at each active UE antennal panel, the RX beams can be fixed/preselected at each time of measurement. The reason for fixed/preselected RX beams (filters) is that the pre-trained machine learning beam prediction model can be a function of the RX beams. Therefore, if the RX beams change, then the model may be identified as a model for retraining.

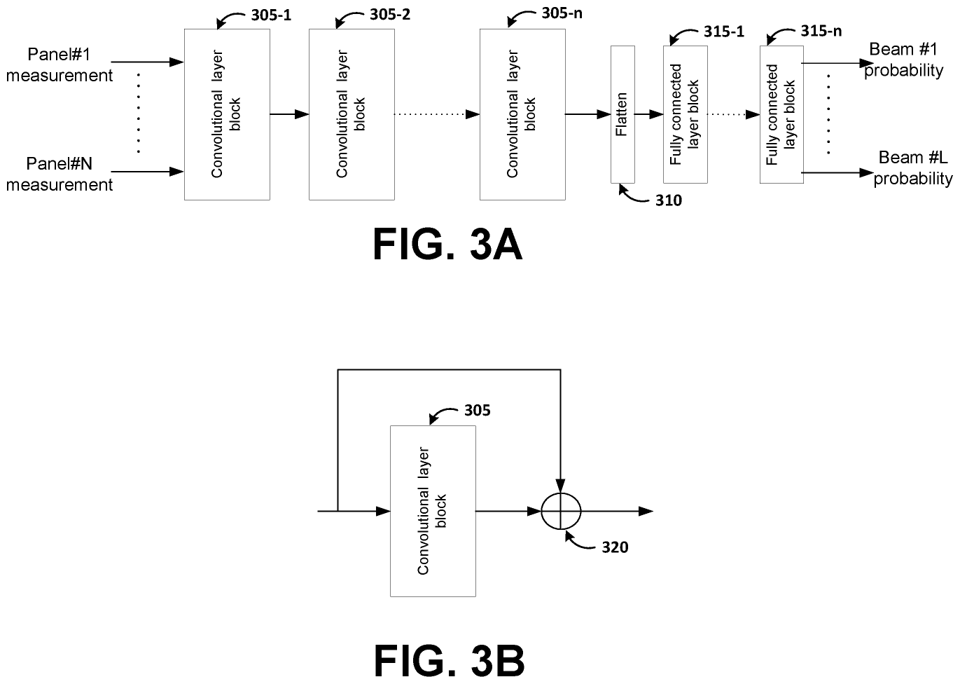

FIG. 3A is a block diagram illustrating a machine learning beam prediction model according to an example embodiment. The input of the model can be the measurement from the active UE panel(s). The measurements can be the complex received signals or received signal powers. The output of the model can be the probability of all the candidate beams from the active UE panels. The model can include a plurality of convolutional layer 305-1, 305-2 . . . , 305-n blocks. The convolutional layer 305-1, 305-2 . . . 305-n can include one-dimensional (1D) and/or two-dimensional (2D) convolutional layer, an activation function layer and a batch normalization layer. The model can include a plurality of fully connected layer 315-1, . . . , 315-n blocks. The fully connected layer 315-1, . . . , 315-n can include a dense layer, an activation layer and a batch normalization layer. The model can include a flatten layer 310 block. The flatten layer 310 can be configured to reshape the input vector.

The machine learning beam prediction model can include residual structure block. An example of the residual structure 320 with a convolutional layer 305 is shown in FIG. 3B. The residual structure 320 can be combined with the convolutional layer 305-1, 305-2 . . . 305-n and/or the fully connected layer 315-1 . . . 315-n. The residual structure 320 can be configured to improve the learning capability of multi-layer neural networks. The UE may have multiple trained beam prediction models (e.g., multiple neural networks) for different panels or different channel statistics. The UE can determine the best trained beam prediction model based on the channel statistic given by network device and/or the current serving DL receiving panel. The trained beam prediction models in the UE can be used for decoding the incident signal to the best beam. The trained beam prediction models may not be dependent on any specific network device. The trained beam prediction models can be related to the incident signal characteristics. The trained beam prediction models deployed in UE can be offline pre-trained before use.

A convolutional layer 305-1, 305-2, . . . , 305-n can have a filter (sometimes called a kernel) and a stride. For example, a filter can be a 1×1 filter (or 1×1×n for a transformation to n output channels, a 1×1 filter is sometimes called a pointwise convolution) with a stride of 1 which results in an output of a cell generated based on a combination (e.g., addition, subtraction, multiplication, and/or the like) of the features of the cells of each channel at a position of the M×M grid. In other words, a feature map having more than one depth or channel is combined into a feature map having a single depth or channel. A filter can be a 3×3 filter with a stride of 1 which results in an output with fewer cells in/for each channel of the M×M grid or feature map. The output can have the same depth or number of channels (e.g., a 3×3×n filter, where n=depth or number of channels, sometimes called a depthwise filter) or a reduced depth or number of channels (e.g., a 3×3×k filter, where k<depth or number of channels). Each channel, depth, or feature map can have an associated filter. Each associated filter can be configured to emphasize different aspects of a channel. In other words, different features can be extracted from each channel based on the filter (this is sometimes called a depthwise separable filter). Other filters are within the scope of this disclosure.

Another type of convolution can be a combination of two or more convolutions, sometimes called a blended convolution. For example, a convolution can be a depthwise and pointwise separable convolution. This can include, for example, a convolution in two steps. The first step can be a depthwise convolution (e.g., a 3×3 convolution). The second step can be a pointwise convolution (e.g., a 1×1 convolution). The depthwise and pointwise convolution can be a separable convolution in that a different filter (e.g., filters to extract different features) can be used for each channel or each depth of a feature map. The convolution can be (or be an element of) a combination of a recurrent neural network and a recursive neural network.

A convolution can be linear. A linear convolution describes the output, in terms of the input, as being linear time-invariant (LTI). Convolutions can also include a rectified linear unit (ReLU). A ReLU is an activation function that rectifies the LTI output of a convolution and limits the rectified output to a maximum. A ReLU can be used to accelerate convergence (e.g., more efficient computation).

Training the beam prediction model can include modifying weights associated with the convolutional layer 305-1, 305-2, . . . , 305-n. Each convolutional layer 305-1, 305-2 . . . 305-n in the beam prediction model can have an associated weight. The associated weights can be randomly initialized and then revised in each training iteration (e.g., epoch). A loss can be generated based on the difference between labelled data and a predicted beam. Training iterations can continue until the loss is minimized and/or until loss does not change significantly from iteration to iteration. In an example implementation, the lower the loss, the better the predicted beam.

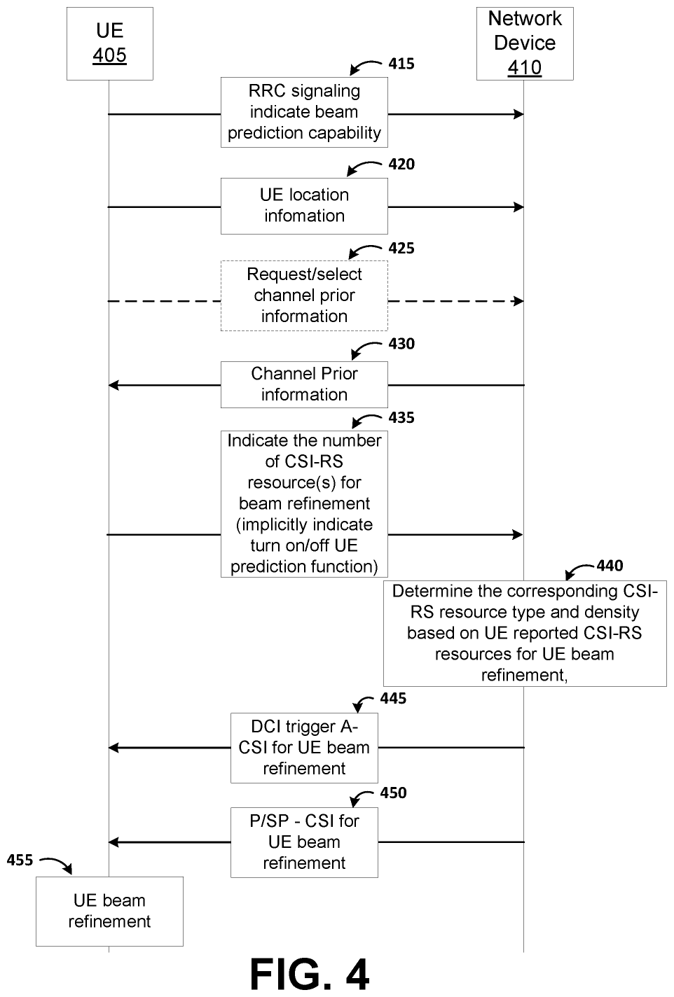

FIG. 4 is a block diagram illustrating a signal flow for UE beam prediction according to an example embodiment. The signal flow can be implemented in a system including a UE 405 and a network device 410 (e.g., a gNB). In block 415, the UE 405 communicates or signals a message to the network device 410. The message can indicate a beam prediction capability. The message can be communicated using radio resource control (RRC) signalling. In block 420, the UE 405 communicates or signals a message to the network device 410. The message can include UE 405 location information. The message can be communicated using RRC signalling.

In block 425, the UE 405 communicates or signals a message to the network device 410. The message can include a request and/or select channel prior information. In block 430, the network device 410 communicates or signals a message to the UE 405. The message can include the channel prior information. In block 435, the UE 405 communicates or signals a message to the network device 410. The message can include an indication of the number of CSI-RS resource(s) for beam refinement (implicitly indicate turn on/off UE prediction function). In block 440, the network device 410, determine the corresponding CSI-RS resource type and density based on the UE 405 reported CSI-RS resources for UE beam refinement.

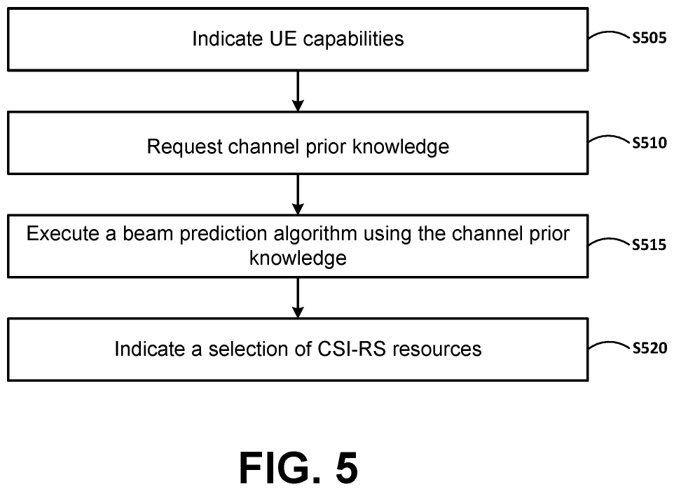

In block 445, the network device 410 communicates or signals a message to the UE 405. The message can include a DCI trigger including an A-CSI for UE beam refinement. In block 450, the network device 410 communicates or signals a message to the UE 405. The message can include a P/SP-CSI for UE beam refinement. In block 455, the UE 405 initiates and performs UE beam refinement. Details associated with the signal flow of FIG. 4 are described with regard to the description of the method of FIG. 5.

FIG. 5 is a block diagram illustrating a method for UE beam prediction according to an example embodiment. As shown in FIG. 5, in step S505 UE capabilities are indicated. In an example implementation, a new higher-layer field may be used to indicate whether a UE is capable of beam prediction and/or indicate whether the UE is capable of beam refinement with a reduced number of DL RS resources. The UE can be configured to transmit radio resource control (RRC) signalling to a network device (e.g., a gNB) to indicate this new field.

In an example implementation, capabilities can be indicated using an RRC UE capability report. For example, a sequence of integers (e.g., instead of an integer) for “max NumberRxBeam” can be reported to the network device. For example, max NumberRxBeam is defined in 38.331-6.6.6-MIMO-ParametersPerBand. If the reported maxNumberRxBeam includes one integer, the UE is not capable of beam prediction functionality can be implied. On the other hand, if the reported maxNumberRxBeam contain multiple integers the UE is capable of beam prediction functionality can be indicated.

Another example implementation of the RRC UE capability signalling design is to have a new RRC UE capability parameter “maxNumberRxBeam_r18” specific for the REL-18+UE maxNumberRxBeam_r18 can be designed as a sequence of integer. The number of the integers and the integers' value are reported by UE. The maximum integer value in maxNumberRxBeam_r18 should be consistent with maxNumberRxBeam. If the reported maxNumberRxBeam_r18 only contains one integer, it implies UE is not capable of beam prediction functionality. On the other hand, if the reported maxNumberRxBeam_r18 contain multiple integers, it implies UE is capable of beam prediction functionality.

In step S510, channel prior knowledge is requested. If the UE is capable of beam prediction, the UE can be configured to transmit signals to the network device to request channel prior knowledge. The channel prior knowledge can be used to (and/or used to help) the UE for beam prediction. If the network device is indicated by the UE that the UE is capable of beam prediction, the network device can be configured to transmit the prior knowledge information to the UE.

The channel prior knowledge requesting signals can also location include the UE location information. The network device can use the UE location information to determine the corresponding channel prior knowledge information for the UE. The network device can receive the channel prior knowledge request and location information from the UE, and/or the network device can receive the location information only. In order to determine the corresponding channel prior knowledge information for the UE, the network device can be configured to obtain the channel prior knowledge information based on some established environment models (e.g., 3D ray-tracing environment model, digital twin environment model) and/or information collected from another UE that previously shared a similar location with the UE.

The channel prior knowledge can include an arrival angle spread statistic, a departure angle spread statistic, a channel multipath number, a channel multipath number strength, arrival angles coherence time, and departure angles coherence time, and/or the like. The category of the channel prior knowledge can be standardized in RRC parameters. The UE can be configured to transmit channel prior knowledge information requesting signals through specific MAC CE signalling to select parts of the prior knowledge from the total standardized channel prior knowledge (e.g., the requesting signal may be a bit sequence in a specific MAC CE to select the needed channel prior information defined in RRC). The network device can be configured to transmit the selected, a portion of, or all channel prior knowledge information to the UE. The network device can be configured to determine a period to re-transmit the channel prior knowledge information to the UE for updating the information.

In step S515, a beam prediction algorithm is executed using the channel prior knowledge. The beam prediction algorithm can be executed (e.g., by a processor of) the UE. In some cases, different channel conditions (e.g., the prior knowledge from the network device), can cause the beam prediction algorithm at different UEs (e.g., UE 230)-1 and UE 230-2) to have different performances. With different UE panel capabilities (e.g., different numbers of active panels for DL RS measurement at each time), different UEs can have different beam prediction performances. For example, a UE that can activate one (1) or two (2) panels may be less capable of identifying the best beam for the incident signal compared to a UE that can activate four (4) panels, and the reason is that the UE with one (1) or two (2) active panels can have a smaller signal space to separate the candidate beams.

With different beam prediction performances, the required number of CSI-RS resources in time for the UE beam prediction process may be different. For example, a less capable UE may need more than one set of fixed beams from the active panels to measure the DL RS for beam refinement and a more capable UE may only need one set of beams (e.g., because of more active panels). An example of UEs using different number of measurement beams is shown in FIG. 2D.

In order to standardize the required performance for UE beam prediction, certain kinds of CSI-RS resources selecting tables may be defined as RRC parameters. A first example of CSI-RS resources selecting table is shown in Table 1, where “MAX” can represent the maximum needed CSI-RS slots for a UE to sweep all beams in the serving panel and/or with “maxNumberRxBeam”, which is defined as UE capability parameter in RRC. This can depend on the UE panel capability. In Table 1, the fraction of MAX under “CSI-RS resource density in time (symbol)” can be replaced by number values (e.g., 1, 2, . . . , etc). The UE may select one index from Table 1 to indicate the CSI-RS resource that may be needed for beam refinement.

TABLE 1

| Index | CSI-RS resource density in time (symbol) |
|---|---|
| 1 | [10% MAX] |
| 2 | [20% MAX] |
| . . . | . . . |
| M | MAX |

A second example of the CSI-RS resources selecting table is shown in Table 2. In Table 2, different SINR index can represent different actual SINR range values and here index 1 can represent the largest SINR range values and index M can represent the smallest SINR range values. For each SINR index, the SINR range values may map to one or multiple CSI-RS resource densities in time. For SINR index 1, the UE with the capability of simultaneously turning on multiple panels for DL RS measurement can have a machine learning model that may need one symbol of CSI-RS resource for beam prediction. Other UEs with the capability of simultaneously turning on fewer panel(s) for DL RS measurement may have a machine learning model that can use more symbols of CSI-RS resources (e.g., two (2) symbols) for beam refinement/prediction. For low SINR index M, a UE machine learning model may not perform as well, and the machine learning model may require N>1 number of CSI-RS in time for beam prediction. For low SINR index M, the machine learning model may require “Max” number of CSI-RS in time for beam prediction.

TABLE 2

| SINR | CSI-RS resource density in time (symbol) |
|---|---|
| 1 | 1 |
| 1 | 2 |
| 2 | 2 |
| . . . | |
| M | N |
| M | Max |

A third example of the CSI-RS resources selecting table is shown in Table 3. The different angular spread index can represent different actual arrival angular spread values, index 1 can represent the smallest arrival angular spread, and level M can represent the largest arrival angular spread. For each arrival angular spread, Table 3 may be used to map to one or multiple CSI-RS resource densities in time. The arrival angular spread information may be collected by gNB through the previous UEs' beam reports.

TABLE 3

| Angular | CSI-RS resource density |
|---|---|
| Spread | in time (symbol) |
| 1 | 1 |
| 1 | 2 |
| 2 | 2 |
| . . . | |
| M | N |
| M | Max |

The “Max” entry in the CSI-RS resource tables may be varied over different UEs. A UE may indicate the “Max” value corresponding to its panel capability. Alternatively (or in addition) the “MAX” value can be predefined in the RRC UE capability as a fixed number and/or with “maxNumberRxBeam”, which is defined as UE capability parameter in RRC. The UE can be configured to select one of the pre-installed beam prediction machine learning models such that the UE has the best beam prediction performance (e.g., beam prediction accuracy) based on the channel prior knowledge node (e.g., multi-path statistic, departure/arrival angular spread, SINR statistic, and the like) from the network. The UE can be configured to transmit signals to the network node in order to select an entry or a subset of entries from the CSI-RS table defined in the higher layer for beam prediction. The transmitted signals can be based on the selected model. For example, the UE can be configured to transmit a bit sequence through a specific MAC CE to select a certain entry from Table 1 or select a subset of entries from Table 2 or Table 3 to indicate to the network device the CSI-RS resources in symbols are needed for UE beam refinement according to different radio environments.

The CSI-RS resource selecting signals from the UE can be implemented through a new specific MAC CE signalling, or the CSI-RS resource selecting signals can be triggered by the network node through DCI and UE transmits the selecting signal through PUCCH or PUSCH. The UE can be configured to select the “MAX” entry from the CSI-RS resource table to fall back to the legacy beam sweeping scheme and indicating no beam prediction will be performed. Selecting one entry other than “MAX” or selecting multiple entries from the table can implicitly indicate that the UE beam prediction function is on. If the UE does not indicate the selection of the CSI-RS resource table, the default may be the “MAX” value.

In another example implementation, indicating a selection of CSI-RS resources can include using a RRC UE capability report including a sequence of integers (e.g., instead of an integer) for “maxNumberRxBeam” and/or a sequence of maxNumberRxBeam or maxNumberRxBeam_r18 transmitted as a specific MAC CE by the down-select integer from the maxNumberRxBeam or maxNumberRxBeam_r18 sequence. The selected value then will be interpreted as the number of needed CSI-RS resources in NW for UE beam refinement.

In RAN4 specification the corresponding test case should be defined for the UE that is capable of beam prediction. Given at least one of a CSI-RS resource table (e.g., table 1, 2, and 3), the new RRC UE capability parameter, and/or the RRC UE capability report, the tested UE configured with an entry from the table (e.g., with the corresponding radio environment), the new RRC UE capability parameter, and/or the RRC UE capability should satisfy some requirements for a certain level of DL/UL throughput (e.g., spectrum efficiency). For example, approximately a 99% DL/UL throughput of the legacy beam sweeping scheme (e.g., without considering the CSI-RS overhead in both schemes), and/or a certain level of accuracy for the beam prediction with any configured entry from the table (with the corresponding radio environment), approximately a 99% accuracy can be used in the specification.

In step S520, a selection of CSI-RS resources is indicated. For example, the network device can be configured to receive the UE's signals indicating the UEs selection of the CSI-RS resources. Then, the network device can be configured to transmit the corresponding number of CSI-RS to the UE for the UE to use in beam refinement/prediction. The CSI-RS resources can be A-CSI or P/SP-CSI, which depends on the CSI-RS resources number for UE beam refinement. For example, if only one symbol of CSI-RS resource is to be used for UE beam refinement/prediction, the P/SP-CSI may be sufficient. If multiple symbols of CSI-RS resources with the same network device TX beam are to be used for UE beam refinement, the network device can be configured to trigger A-CSI for UE beam refinement.

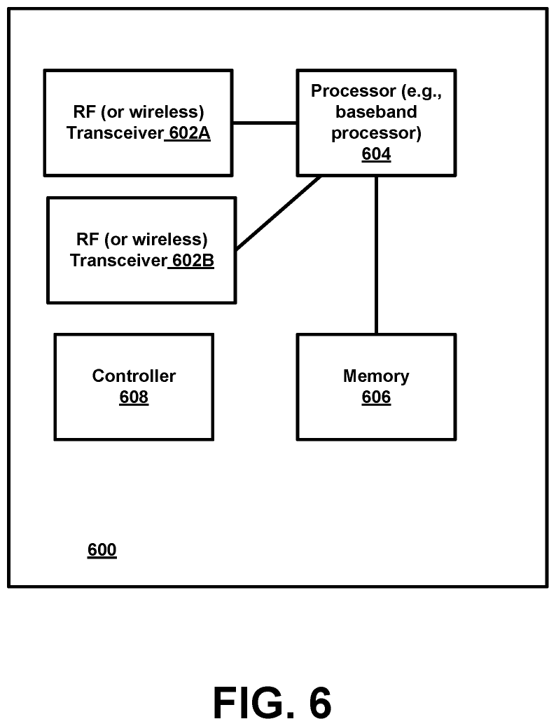

FIG. 6 is a block diagram of a wireless station 600 or wireless node or network node 600 according to an example embodiment. The wireless node or wireless station or network node 600 may include, e.g., one or more of an AP, BS, gNB, RAN node, relay node, UE or user device, network node, network entity, DU, CU-CP, CU-UP, . . . or other node) according to an example embodiment.

The wireless station 600 may include, for example, one or more (e.g., two as shown in FIG. 6) radio frequency (RF) or wireless transceivers 602A, 602B, where each wireless transceiver includes a transmitter to transmit signals and a receiver to receive signals. The wireless station also includes a processor or control unit/entity (controller) 604 to execute instructions or software and control transmission and receptions of signals, and a memory 606 to store data and/or instructions.

Processor 604 may also make decisions or determinations, generate frames, packets or messages for transmission, decode received frames or messages for further processing, and other tasks or functions described herein. Processor 604, which may be a baseband processor, for example, may generate messages, packets, frames or other signals for transmission via wireless transceiver 602 (602A or 602B). Processor 604 may control transmission of signals or messages over a wireless network, and may control the reception of signals or messages, etc., via a wireless network (e.g., after being down-converted by wireless transceiver 602, for example). Processor 604 may be programmable and capable of executing software or other instructions stored in memory or on other computer media to perform the various tasks and functions described above, such as one or more of the tasks or methods described above. Processor 604 may be (or may include), for example, hardware, programmable logic, a programmable processor that executes software or firmware, and/or any combination of these. Using other terminology, processor 604 and transceiver 602 together may be considered as a wireless transmitter/receiver system, for example.

In addition, referring to FIG. 6, a controller (or processor) 608 may execute software and instructions, and may provide overall control for the station 600, and may provide control for other systems not shown in FIG. 6, such as controlling input/output devices (e.g., display, keypad), and/or may execute software for one or more applications that may be provided on wireless station 600, such as, for example, an email program, audio/video applications, a word processor, a Voice over IP application, or other application or software.

In addition, a storage medium may be provided that includes stored instructions, which when executed by a controller or processor may result in the processor 604, or other controller or processor, performing one or more of the functions or tasks described above.

According to another example embodiment, RF or wireless transceiver(s) 602A/602B may receive signals or data and/or transmit or send signals or data. Processor 604 (and possibly transceivers 602A/602B) may control the RF or wireless transceiver 602A or 602B to receive, send, broadcast or transmit signals or data.

### Some Example Advantages

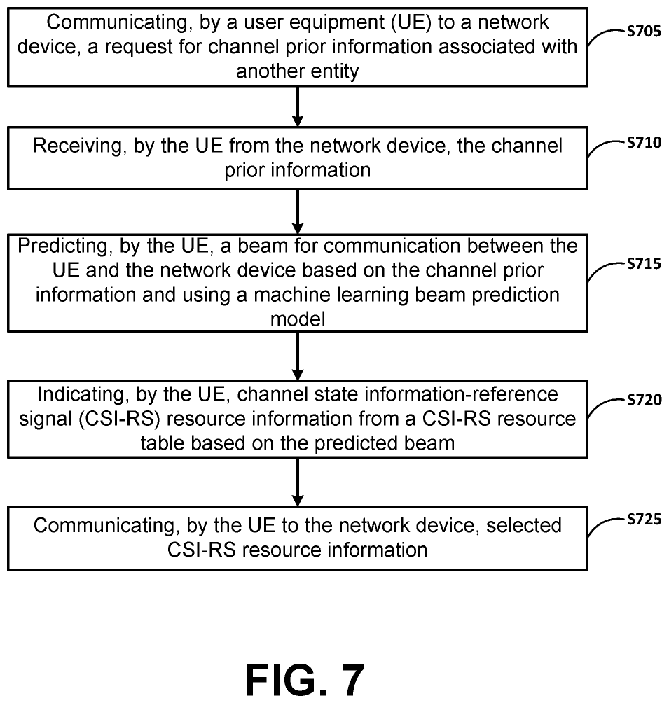

Example 1. FIG. 7 is a block diagram illustrating a method for operating a user equipment (UE) according to an example embodiment. The method including, in step S705, communicating, by the UE to a network device, a request for channel prior information associated with another entity. In step S710, receiving, by the UE from the network device, the channel prior information. In step S715, predicting, by the UE, a beam for communication between the UE and the network device based on the channel prior information and using a machine learning beam prediction model. In step S720, indicating, by the UE, channel state information-reference signal (CSI-RS) resource information from a CSI-RS resource table based on the predicted beam. In step S725, communicating, by the UE to the network device, selected CSI-RS resource information.

Example 2. The method of Example 1, wherein the indicating of the CSI-RS resource information can be further based on at least one of a UE previous downlink (DL) reference signal (RS) measurement and a requested number of beam measurements.

Example 3. The method of Example 1 or Example 2, the method can further include signalling, by the UE to the network device, a beam prediction capability of the UE and communicating, by the UE to the network device, location information associated with the UE.

Example 4. The method of Example 1 to Example 3, the method can further include signalling, by the UE to the network device, the UE is capable of beam prediction using a sequence of integers in a field of an RRC UE capability report.

Example 5. The method of Example 1 to Example 4, the method can further include measuring a downlink (DL) reference signal (RS), wherein predicting the beam is further based on the DL RS measurement.

Example 6. The method of Example 1 to Example 5, wherein the channel prior information can include at least one of an arrival angle spread statistic, a departure angle spread statistic, a channel multipath number, a channel multipath number strength, arrival angles coherence time, and departure angles coherence time.

Example 7. The method of Example 6, wherein the arrival angle spread statistic can be based on data associated with another UE collected over different times as stored by the network device.

Example 8. The method of Example 1 to Example 7, wherein the request for channel prior information can be a bit sequence communicated using MAC CE signaling indicating selected channel prior information.

Example 9. The method of Example 1 to Example 8, the method can further include selecting a trained beam prediction model based on at least one of the channel prior information, a panel capability associated with the UE, and a previous DL RS measurement of the UE.

Example 10. The method of Example 1 to Example 9, wherein the indicating of the CSI-RS resource information can be further based on one of a SINR range and an angular spread.

Example 11. The method of Example 1 to Example 10, the method can further include determining whether or not the beam prediction has failed and in response to determining the beam prediction has failed, indicating default CSI-RS resource information.

Example 12. The method of Example 1 to Example 11, wherein the communicating of the selected CSI-RS resource information can include indicating a selection of CSI-RS resources using a RRC UE capability report including a sequence of integers.

Example 13. The method of Example 1 to Example 12, wherein the beam prediction model can be a neural network.

Example 14. The method of Example 13, wherein the neural network can be configured to map an incident signal to a best beam received by the UE for communication between the UE and the network device.

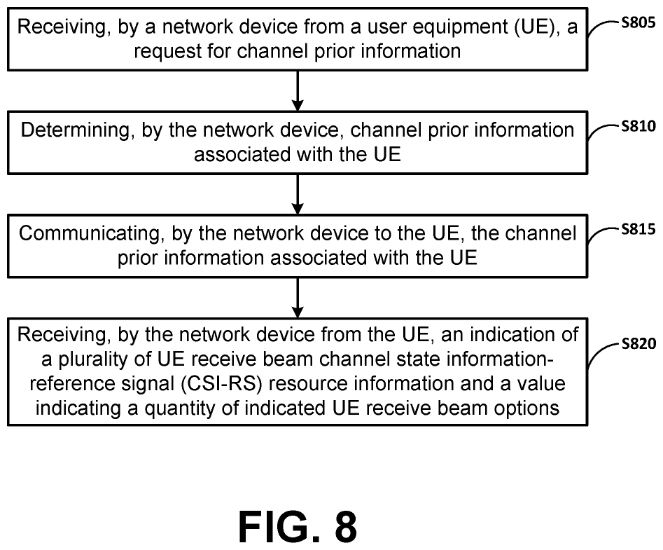

Example 15. FIG. 8 is a block diagram illustrating a method for operating a network device (e.g., gNB) according to an example embodiment. The method including, in step S805, receiving, by a network device from a user equipment (UE), a request for channel prior information. In step S810, determining, by the network device, channel prior information associated with the UE. In step S815, communicating, by the network device to the UE, the channel prior information associated with the UE. In step S820, receiving, by the network device from the UE, an indication of a plurality of UE receive beam channel state information-reference signal (CSI-RS) resource information and a value indicating a quantity of indicated UE receive beam options.

Example 16. The method of Example 13, the method can further include determining, by the network device, a CSI-RS resource type and a CSI-RS resource density based on the CSI-RS resource information.

Example 17. The method of Example 13 or example 16, the method can further include triggering, by the network device, a UE beam refinement process based on a CSI-RS resource type and a CSI-RS resource density.

Example 18. The method of Example 13 to example 17, the method can further include receiving a signal, by the network device from the UE, indicating a beam inferring capability of the UE and receiving, by the network device from the UE, location information associated with the UE.

Example 19. The method of Example 13 to example 18, wherein the channel prior information can include at least one of an arrival angle spread statistic, a departure angle spread statistic, a channel multipath number, and a channel multipath number strength, arrival angles coherence time, and departure angles coherence time.

Example 20. The method of Example 13 to example 19, wherein the request for channel prior information can be a bit sequence communicated using MAC CE signaling indicating selected channel prior information.

Example 21. A non-transitory computer-readable storage medium comprising instructions stored thereon that, when executed by at least one processor, are configured to cause a computing system to perform the method of any of Examples 1-20.

Example 22. An apparatus comprising means for performing the method of any of Examples 1-20.

Example 23. An apparatus comprising at least one processor and at least one memory including computer program code, the at least one memory and the computer program code configured to, with the at least one processor, cause the apparatus at least to perform the method of any of Examples 1-20.

The example embodiments are not, however, restricted to the system that is given as an example, but a person skilled in the art may apply the solution to other communication systems. Another example of a suitable communications system is the 5G system. It is assumed that network architecture in 5G will be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labor between core network operations and base station operations may differ from that of the LTE or even be non-existent.

Example embodiments of the various techniques described herein may be implemented in digital electronic circuitry, or in computer hardware, firmware, software, or in combinations of them. Example embodiments may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IoT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, example embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices: magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Example embodiments may be implemented in a computing system that includes a back-end component, e.g., as a data server, or that includes a middleware component, e.g., an application server, or that includes a front-end component, e.g., a client computer having a graphical user interface or a Web browser through which a user can interact with an embodiment, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1-80. (canceled)

81. An apparatus, comprising:
at least one processor; and
at least one memory including computer program code;
the at least one memory and the computer program code configured to, with the at least one processor, cause the apparatus at least to:
communicate, to a network device, a request for channel prior information;
receive, from the network device, the channel prior information;
predict a beam for communication between the apparatus and the network device based on the channel prior information and using a machine learning beam prediction model; and
indicate a selection of channel state information-reference signal (CSI-RS) resource information from a CSI-RS resource table based on the predicted beam.

82. The apparatus of claim 81, wherein the indicating of the selection of CSI-RS resource information is further based on at least one of previous downlink reference signal measurement or a requested number of beam measurements.

83. The apparatus of claim 81, wherein the apparatus is further caused to:
signal, to the network device, a beam prediction capability of the apparatus; and
communicate, to the network device, location information associated with the apparatus.

84. The apparatus of claim 81, wherein the apparatus is further caused to:
signal, to the network device, the apparatus is capable of beam prediction using a sequence of integers in a field of a radio resource control user equipment capability report.

85. The apparatus of claim 81, wherein the apparatus is further caused to:
measure a downlink reference signal, wherein predicting the beam is further based on the downlink reference signal measurement.

86. The apparatus of claim 81, wherein the channel prior information includes at least one of an arrival angle spread statistic, a departure angle spread statistic, a channel multipath number, a channel multipath number strength, arrival angles coherence time, or departure angles coherence time.

87. The apparatus of claim 86, wherein the arrival angle spread statistic is based on data associated with a user equipment collected over different times as stored by the network device.

88. The apparatus of claim 81, wherein the request for channel prior information is a bit sequence communicated using medium access control control element (MAC CE) signaling indicating selected channel prior information.

89. The apparatus of claim 81, wherein the apparatus is further caused to select a trained beam prediction model based on at least one of the channel prior information, a panel capability associated with the apparatus, or a previous downlink reference signal measurement.

90. The apparatus of claim 81, wherein the indicating of the selection of CSI-RS resource information is further based on at least one of a signal to interference and noise ratio range or an angular spread.

91. The apparatus of claim 81, wherein the apparatus is further caused to:
determine whether or not the beam prediction has failed; and
in response to determining the beam prediction has failed, indicating default CSI RS resource information.

92. The apparatus of claim 81, wherein the indicating the selection of CSI-RS resource information comprises indicating the selection of CSI-RS resource information using a radio resource control user equipment capability report including a sequence of integers.

93. The apparatus of claim 81, wherein the beam prediction model is a neural network.

94. The apparatus of claim 93, wherein the neural network is configured to map an incident signal to a best beam received by the apparatus for communication between the apparatus and the network device.

95. An apparatus comprising:
at least one processor; and
at least one memory including computer program code;
the at least one memory and the computer program code configured to, with the at least one processor, cause the apparatus at least to:
receive, from a user equipment (UE), a request for channel prior information;
determine channel prior information associated with the UE;
communicate to the UE the channel prior information associated with the UE; and
receive, from the UE, an indication of a plurality of UE receive beam channel state information-reference signal (CSI-RS) resource information and a value indicating a quantity of indicated UE receive beam options.

96. The apparatus of claim 95, wherein the apparatus is further caused to:
determine CSI-RS resource type and a CSI-RS resource density based on the CSI-RS resource information.

97. The apparatus of claim 95, wherein the apparatus is further caused to:
trigger a UE beam refinement process based on a CSI RS resource type and a CSI-RS resource density.

98. The apparatus of claim 95, wherein the apparatus is further caused to:
receive a signal from the UE indicating a beam inferring capability of the UE; and
receive from the UE location information associated with the UE.

99. The apparatus of claim 95, wherein the channel prior information includes at least one of an arrival angle spread statistic, a departure angle spread statistic, a channel multipath number, and a channel multipath number strength, arrival angles coherence time, or departure angles coherence time.

100. A method comprising:
communicating, by a user equipment (UE) to a network device, a request for channel prior information associated with another entity;
receiving, by the UE from the network device, the channel prior information;
predicting, by the UE, a beam for communication between the UE and the network device based on the channel prior information and using a machine learning beam prediction model; and
indicating, by the UE, a selection of channel state information-reference signal (CSI-RS) resource information from a CSI-RS resource table based on the predicted beam.
